(19) United States
(12) Patent Application Publication
(10) Pub. No.: US 2008/0288292 A1
(43) Pub. Date: Nov. 20, 2008

(54) System and Method for Large Scale Code Classification for Medical Patient Records

(75) Inventors: Jinbo Bi, Chester Springs, PA (US); Lucian Vlad Lita, San Jose, CA (US); Radu Stefan Niculescu, Malvern, PA (US); R. Bharat Rao, Berwyn, PA (US); Shipeng Yu, Exton, PA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Medical Solutions USA, Inc., Malvern, PA (US)

(21) Appl. No.: 12/119,778

(22) Filed: May 13, 2008

Related U.S. Application Data
(60) Provisional application No. 60/938,042, filed on May 15, 2007.

(51) Int. Cl. G06Q 50/00; G06F 17/11; G06F 15/18

(52) U.S. Cl. 705/3; 706/12

(57) ABSTRACT

A method for training classifiers for ICD-9 patient codes includes providing a set of documents regarding patient hospital visits, combining the documents for each patient visit to create a hospital visit profile, defining a feature as an ngram with a frequency of occurrence greater or equal to a predetermined value that does not appear in a standard list of ngrams, processing the profiles to remove redundancy at a paragraph level and perform tokenization and sentence splitting, performing feature selection, randomly dividing the documents into training, validation, and test sets, and training a set of binary classifiers using a weighted ridge regression, each binary classifier targeting a single ICD-9 code using the training set, wherein each classifier is adapted to determining a specific ICD-9 code by analyzing a patient's hospital records.

### CROSS REFERENCE TO RELATED UNITED STATES APPLICATIONS

This application claims priority from “Large Scale Code Classification for Medical Patient Records”, U.S. Provisional Application No. 60/938,042 of Lita, et al., filed May 15, 2007, the contents of which are herein incorporated by reference in their entirety.

### TECHNICAL FIELD

This disclosure is directed to the accurate labeling of patient records according to diagnoses and procedures that patients have undergone.

### DISCUSSION OF THE RELATED ART

Medical coding is best described as a translation from an original language in medical documentation regarding diagnoses and procedures related to a patient into a series of code numbers that describe the diagnoses or procedures in a standard manner. Medical coding influences which medical services are paid, how much they should be paid and whether a person is considered a “risk” for insurance coverage. Medical coding is an essential activity that is required for reimbursement by all medical insurance providers. It drives the cash flow by which health care providers operate. Additionally, it supplies critical data for quality evaluation and statistical analysis. In order to be reimbursed for services provided to patients, hospitals need to provide proof of the procedures that they performed. Currently, this is achieved by assigning a set of CPT (Current Procedural Terminology) codes to each patient visit to the hospital. Providing these codes is not enough for receiving reimbursement: in addition, hospitals need to justify why the corresponding procedures have been performed. In order to do that, each patient visit needs to be coded with the appropriate diagnosis that require the above procedures.

There are several standardized systems for patient diagnosis coding, with ICD-9 (International Classification of Diseases, Manual of the International Statistical Classification or Diseases, Injuries, and Causes of Death, World Health Organization, Geneva, 1997) being the version currently in use. In most cases, an ICD-9 code is a real number consisting of a 2-3 digit disease category followed by a 1-2 decimal subcategory. For instance, the ICD-9 code of 428 represents Heart Failure (HF), with subcategories 428.0 (Congestive HF, Unspecified), 428.1 (Left HF), 428.2 (Systolic HF), 428.3 (Diastolic HF), 428.4 (Combined HF) and 428.9 (HF, Unspecified). There are more than 12,000 different ICD-9 diagnosis codes with a sophisticated hierarchy and interplay among exams, decision-making, and documenting the diagnosis.

The coding approach currently used in hospitals relies heavily on manual labeling performed by skilled and/or semi-skilled personnel. This is not only a time consuming process, but also very error-prone given the large number of ICD-9 codes and patient records. This can be partly explained by the fact that coding is done by medical abstractors who often lack the medical expertise to properly reach a diagnosis. Two situations frequently occur: “over-coding”, which is assigning a code for a more serious condition than is justified, and “under-coding”, which refers to missing codes for existing procedures/diagnoses. Both situations translate into financial loses for insurance companies in the first case and for hospitals in the second case.

In additional, accurate coding is important because ICD9 codes are widely used in determining patient eligibility for clinical trials as well as in quantifying hospital compliance with quality initiatives. Some studies show that only 60% to 80% of the assigned ICD-9 codes reflect the exact patient medical diagnosis. Furthermore, variations in medical language usage can be found in different geographic locales, and the sophistication of the term usage also varies among different types of medical personnel. Therefore, an automatic medical coding system would be useful and would not only speed up the process, but also improve coding accuracy.

Classification under a supervised learning setting has been a standard task in the fields of machine learning or data mining, which learn to construct inference models from data with known assignments, from which models can be generalized to unseen data for code prediction. However, these methods have rarely been employed for automatic assignment of medical codes such as ICD9 codes to medical records. Part of the reason is that the data and labels are challenging to obtain. Hospitals are usually reluctant to share their patient data with research communities, and sensitive information, such as patient name, date of birth, home address, social security number, has to be anonymized to meet HIPAA (Health Insurance Portability and Accountability Act) standards. Another reason is that the code classification task is itself very challenging. Patient records contain a lot of noise, due to misspellings, abbreviations, etc, and understanding the records correctly is important to make correct code predictions.

A health care organization can significantly improve its performance by implementing an automated system that integrates patients documents, tests with standard medical coding system and billing systems. Such a system can offer large health care organizations a means to eliminate costly and inefficient manual processing of code assignments, thereby improving productivity and accuracy. Early efforts dedicated to automatic or semi-automatic assignments of ICD9 codes demonstrate that simple machine learning approaches such as k-nearest neighbor, relevance feedback, or Bayesian independence classifiers can be used to acquire knowledge from already-coded training documents. The identified knowledge is then employed to optimize the means of selecting and ranking candidate codes for the test document. Often a combination of different classifiers produce better results than any single type of classifier. Occasionally, human interaction is still needed to enhance the code assignment accuracy.

Current ICD9 code assignment systems typically work with a rule-based engine and display different ICD9 codes for a trained medical abstractor to look at and manually assign proper codes to patient records. Similar code assignment systems can automatically categorize patient documents according to meaningful groups, but not necessarily in terms of medical codes. For instance, in de Lima et al., “A hierarchical approach to the automatic categorization of medical documents”, CIKM, 1998, classifiers were designed and evaluated using a hierarchical learning approach. Recent works (cf. Halasz et al., “The NGram cc classifier: A novel method of automatically creating cc classifiers based on ICD9 groupings”, Advances in Disease Surveillance, 1(30) 2006) also utilize NGram techniques to automatically create Chief Complaints classifiers based on ICD-9 groupings.

In Rao et al, “Clinical and financial outcomes analysis with existing hospital patient records” SIGKDD, the authors present a small scale approach to assigning ICD-9 codes of Diabetes and Acute Myocardial Infarction (AMI) on a small population of patients. Their approach is semi-automatic, consisting of association rules implemented by an expert, which are further combined in a probabilistic fashion. However, given the high degree of human interaction involved, their method will not be scalable to a large number of medical conditions. Moreover, the authors do not further classify the subtypes within Diabetes or AMI.

Recently, the Computation Medicine Center sponsored an international challenge task on this type of text classification task. (See http://www.computationalmedicine.org/challenge/index.php.) About 2,216 documents are carefully extracted, including training and testing, and 45 ICD9 labels, with 94 distinct combinations, were used for these documents. More than 40 groups submitted results, and the best macro and micro F1 measures being 0.89 and 0.77, respectively. The competition is a worthy effort in the sense that it provided a test bed to compare different algorithms. Unfortunately, public datasets are to date much smaller than the patient records in even a small hospital. Moreover, many of the documents are very simple, being only one or two sentences. It is challenging to train good classifiers based on such a small data set (even the most common label 786.2 (for “Cough”) has only 155 reports to train on), and the generalizability of the obtained classifiers is also problematic.

### SUMMARY OF THE INVENTION

Exemplary embodiments of the invention as described herein generally include methods and systems for approaching medical coding as a multi-label classification task, where each code is treated as a label for patient records. An algorithm according to an embodiment of the invention can efficiently handle large-scale patient records, taking into account inter-code correlations, and experimental results are presented on existing hospital patient data. According to embodiments of the invention, statistical/machine learning approaches to the coding of patient records include vector machine techniques and ridge regression techniques. These techniques approach the task at a patient visit level, not at a specific document level, nor at the overall patient record level, so each visit/hospital stay is assigned specific codes. Further, techniques according to embodiments of the invention have chained and adapted data collection, processing, algorithms and experiments in an approach that works automatically on large datasets, not in a specific sub-domain, nor on a limited number of patients, nor on an artificially created/modified dataset. According to a further embodiment of the invention, a variant of ridge regression, called weighted ridge regression, is applied to the highly unbalanced data in automatic large scale ICD-9 coding of medical patient records. Since most ICD-9 codes are unevenly represented in medical records, a weighted scheme is employed to balance positive and negative examples. The weights can be associated with the instance priors from a probabilistic interpretation, and an efficient EM algorithm can automatically update both the weights and the regularization parameter. Experiments on a large-scale real patient database suggest that the weighted ridge regression outperforms the conventional ridge regression and linear support vector machines (SVM).

According to an aspect of the invention, there is provided a method for training classifiers for ICD-9 patient codes, the method including providing a set of documents regarding patient hospital visits, combining the documents for each patient visit to create a hospital visit profile, defining a feature as an ngram with a frequency of occurrence greater or equal to a predetermined value that does not appear in a standard list of ngrams, processing the profiles to remove redundancy at a paragraph level and perform tokenization and sentence splitting, performing feature selection, randomly dividing the documents into training, validation, and test sets, and training a set of binary classifiers, each binary classifier targeting a single ICD-9 code using the training set, wherein each classifier is adapted to determining a specific ICD-9 code by analyzing a patient's hospital records.

According to a further aspect of the invention, the documents include specific procedure reports and full hospital visit records for a particular patient.

According to a further aspect of the invention, the method includes processing the tokens, including replacing all numbers with a same token, replacing all personal pronouns with a similar token, and replacing other classes of words/ngrams with special tokens.

According to a further aspect of the invention, the method includes adjusting classifier parameters using the validation set, and testing the classifiers on the test set.

According to a further aspect of the invention, the binary classifier is trained using a support vector machine with a linear kernel.

According to a further aspect of the invention, a cost function of the support vector machine assigns equal value to all ICD-9 classes.

According to a further aspect of the invention, a cost function of the support vector machine assigns a class cost equal to a ratio of negative to positive examples.

According to a further aspect of the invention, the binary classifier is trained using a Bayesian ridge regression using a Gaussian prior of form w˜N(μ_{w},Σ_{w}), with mean μ_{w} and covariance Σ_{w} for parameter vector w, wherein w^{T}x approximates an ICD-9 code label y for a feature vector x, with y_{iε}{+1, −1} indicating whether the feature vector x is associated with the ICD-9 code, and a likelihood of labels y=[y₁, . . . , yₙ]^{T}

$$P ( y ) = \int {\prod }_{i = 1}^{n} P ( {y}_{i} \vert {w}^{T} {x}_{i} ) P ( w \vert {μ}_{w} , {Σ}_{w} ) d w ,$$

with P(yᵢ|w^{T}xᵢ) being a probability that features xᵢ take the label yᵢ., wherein p(yᵢ|w^{T}xᵢ) is a Gaussian, with yᵢ˜N(w^{T}xᵢ, σ²), and σ² is a model parameter.

According to a further aspect of the invention, the model parameter σ² is determined by maximizing the likelihood of labels with respect to σ².

According to a further aspect of the invention, training a binary classifier comprises defining a sample set of pairs (xᵢ; yᵢ), i=1, . . . , N, wherein xᵢεR^{d} is an i^{-th} feature vector and y_{iε}{+1, −1} is a corresponding ICD-9 label and y a label vector of N labels, defining a feature matrix XεR^{N×d} whose i^{-th} row contains features for an i^{-th} feature vector xᵢ, defining a set of weights αᵢ>0 for the i^{-th} feature vector xᵢ wherein A is a N×N diagonal matrix with its (i, i)^{-th} entry being αᵢ, defining a set of hyperplane parameters w=(X^{T}AX+σ²I)⁻¹X^{T}Ay, estimating a Gaussian posterior N(μ_{w}, C_{w}) of w with mean μ_{w} and covariance C_{w} by calculating μ_{w}=(X^{T}AX+σ²I)⁻¹ X^{T}Ay, C_{w}=σ²(X^{T}AX+σ²I)⁻¹, and updating σ² and αᵢ from

$${σ}^{2} = \frac{1}{N} [ {( y - Xw )}^{T} A ( y - Xw ) + tr ( {XC}_{w} {X}^{T} A ) ] , \\ {α}_{i} = \frac{{σ}^{2}}{{( {y}_{i} - {w}^{T} {x}_{i} )}^{2} + {x}_{i}^{T} {C}_{w} {x}_{i}} ;$$

and repeating the steps of estimating the Gaussian posterior N(μ_{w}, C_{w}) and updating σ² and αⁱ until values of σ² and αᵢ have converged.

According to a further aspect of the invention, the labels yᵢ follow a Gaussian distribution

$${y}_{i} ∼ N ( {w}^{T} {x}_{i} , \frac{{σ}^{2}}{{α}_{i}} )$$

with mean w^{T}xᵢ and variance

$$\frac{{σ}^{2}}{{α}_{i}} .$$

According to a further aspect of the invention, the method includes normalizing A such that tr(A)=1 after each update.

According to a further aspect of the invention, the method includes constraining all positive-labeled feature vectors to share one weight α₊, and all the negative labeled feature vectors to share one weight α₋, wherein the updates are

$${α}_{+} = \frac{1}{{N}_{+}} {\sum }_{\{ i \vert {y}_{i} = + 1 \}} \frac{{σ}^{2}}{{( {y}_{i} - {w}^{T} {x}_{i} )}^{2} + {x}_{i}^{T} {C}_{w} {x}_{i}} , \\ {α}_{-} = \frac{1}{{N}_{-}} {\sum }_{\{ i \vert {y}_{i} = - 1 \}} \frac{{σ}^{2}}{{( {y}_{i} - {w}^{T} {x}_{i} )}^{2} + {x}_{i}^{T} {C}_{w} {x}_{i}} ,$$

where N₊ and N₋ are the numbers of positive and negative feature vectors, respectively.

According to a further aspect of the invention, the method includes normalizing α₊+α₋=1.

According to another aspect of the invention, there is provided a program storage device readable by a computer, tangibly embodying a program of instructions executable by the computer to perform the method steps for training classifiers for ICD-9 patient codes.

### BRIEF DESCRIPTION OF THE DRAWINGS

FIGS. 1a-b is a flowchart of a method for training classifiers for ICD-9 patient codes, according to an embodiment of the invention.

FIG. 2 is a table of statistics of the five most frequent ICD-9 codes in the patient record database, according to an embodiment of the invention.

FIG. 3 is a table of the results on the top five ICD-9 codes for both the support-vector machine and Bayesian ridge regression classification approaches, according to an embodiment of the invention.

FIG. 4 is a graph of the ROC curve for the support-vector machine ICD-9 classifier, according to an embodiment of the invention.

FIG. 5 is a graph of the ROC curve for the Bayesian ridge regression ICD-9 classifier, according to an embodiment of the invention.

FIG. 6 is a table of statistics of the 50 most frequent ICD-9 codes in the patient record database, according to an embodiment of the invention.

FIG. 7 is a graph of the frequency of the 50 ICD-9 codes, according to an embodiment of the invention.

FIGS. 8(a)-(d) are graphs of the F1 and AUC curves with respect to a for two representative ICD-9 codes, according to an embodiment of the invention.

FIG. 9 is a table that shows the experiment results for the precision, recall, F1, and AUC over all 50 ICD-9 codes, according to an embodiment of the invention.

FIG. 10 is a graph of the F1 curves for the canonical ridge regression and the weighted ridge regression, and the difference curve, for the to 50 ICD-9 codes, according to an embodiment of the invention.

FIG. 11 is a block diagram of an exemplary computer system for implementing a method for accurate labeling of patient records according to diagnoses and procedures that patients have undergone, according to an embodiment of the invention.

### DETAILED DESCRIPTION OF EXEMPLARY EMBODIMENTS

Exemplary embodiments of the invention as described herein generally include systems and methods for accurate labeling of patient records according to diagnoses and procedures that patients have undergone. Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention.

### ICD-9 Codes & Patient Records

Automatic prediction of the ICD-9 codes is a challenging task. The diagnosis coding task is complex in that the concept of a document is not well defined. First, for every patient in the medical database there are one or more visits to one or more hospitals, have different lab results and undergo various treatments. Thus these experiments focus on data from only one hospital. During each hospital visit, patients undergo several examinations, treatments and procedures, as well as evaluations. For most of these events, documents in electronic format are authored by different people with different qualifications (e.g., physician, nurse, etc). Physicians and nurses generate free text data either by typing the information themselves or by using a local or remote speech-to-text engine. The input method also affects text quality and therefore could impact the performance of classifiers based on this data. Each of these documents inserted in the patient database represents an event in the patient's hospital stay: e.g., radiology note, personal physician note, lab test, etc. In addition, patient records often include medical history, such as past medical conditions and medications, and family history, such as parents' chronic diseases. By embedding unstructured medical information that does not directly describe a patient's state, the data becomes noisier. The number of documents varies from 1 to more than 200 per patient. Because of all of these elements, the patient data will be very unbalanced in the number of medical notes per patient visit.

A difference between medical patient record classification and general text classification is word distribution. Depending on the type of institution, department profile, and patient cohort, phrases such as “discharge summary”, “chest pain”, and “ECG” may be ubiquitous in the corpus and thus not carry a great deal of information for a classification task. Consider the phrase “chest pain”: intuitively, it should correlate well with the ICD-9 code 786.50, which corresponds to the condition chest pain. However, through the nature of the corpus, this phrase appears in well over half of the documents, many of which do not belong to the 786.50 category.

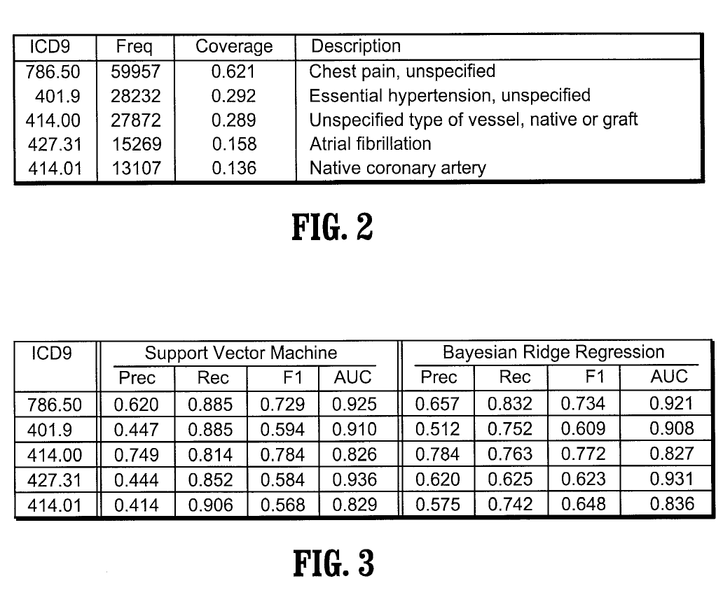

In the experiments described herein the notes for each patient visit were combined to create a hospital visit profile that is defined to be an individual document. The corpus extracted from the patient database contains diagnostic codes for each individual patient visit, and therefore for each of our documents. A 1.3 GB corpus using medical patient records was extracted from a real single-institution patient database. This is useful since most published previous work was performed on very small datasets. Due to privacy concerns, since the database contains identified patient information, it cannot be made publicly available. Each document contains a full hospital visit record for a particular patient. Each patient may have several hospital visits, some of which may not be documented if they choose to visit multiple hospitals. This dataset contains 96,557 patient visits, each labeled with a one or more ICD-9 codes. There are 2618 distinct ICD-9 codes associated with these visits, with the top five most frequent summarized in the table shown in FIG. 2, along with the corresponding coverage, i.e. the fraction of documents in the corpus that were coded with the particular ICD-9 code. Given sufficient patient records supporting a code, this disclosure investigates the performance of statistical classification techniques, and focuses on correct classification of high-frequency diagnosis codes.

### Support Vector Machines

One classification method according to an embodiment of the invention uses support vector machines (SVM), which perform well on textual data. The experiments presented herein use the SVM Light toolkit developed by Thorsten Joachims, available at http://svmlight.joachims.org/, with a linear kernel and a target positive-to-negative example ratio defined by the training data. Different cost functions were used, including one that assigns equal value to all classes, as well as one using a target class cost equal to the ratio of negative to positive examples. The results shown herein correspond to SVM classifiers trained using the latter cost function. Note that better results may be obtained by tuning such parameters on a validation set.

### Bayesian Ridge Regression

Another classification method according to an embodiment of the invention uses a probabilistic approach based on Gaussian processes. A Gaussian process (GP) is a stochastic process that defines a nonparametric prior over functions in Bayesian statistics. Consider a sample set of pairs (xᵢ; yᵢ), i=1, . . . , N, where xᵢεR^{d} is the i^{-th} feature vector and yᵢε{+1, −1} is the corresponding label. A hyperplane-based function can be constructed to approximate the output y. In a linear case, where the function has linear form, f(x)=w^{T}x, the GP prior on f is equivalent to a Gaussian prior on w, which takes the form w˜N(μ_{w},Σ_{w}), with mean μ_{w} and covariance Σ_{w}. Then the likelihood of labels y=[y₁, . . . , yₙ]^{T} is

$$P ( y ) = \int {\prod }_{i = 1}^{n} P ( {y}_{i} \vert {w}^{T} {x}_{i} ) P ( w \vert {μ}_{w} , {Σ}_{w} ) d w , \qquad ( 1 )$$

with P(yᵢ|w^{T}xᵢ) the probability that document xᵢ takes label yᵢ.

In general one fixes μ_{w}=0, and Σ_{w}=I with I the identity matrix. One exemplary, non-limiting choice for P(yᵢ|W^{T}Xᵢ) is a Gaussian, with yᵢ˜N(w^{T}xᵢ, σ²), with σ² a model parameter. Since everything is Gaussian here, the a posteriori distribution of w conditioned on the observed labels, P(w|y, σ²), is also a Gaussian, with mean

\hat{μ}_{w}=(X^{T}X+σ²I)⁻¹X^{T}y, (2)

where X=[x₁, . . . , xₙ]^{T} is a n×d matrix. The only model parameter σ² can also be optimized by maximizing the likelihood of EQ. (1) with respect to σ². Finally, for a test document x*, its label was predicted to be \hat{μ}_{w}^{T}x* with the optimal σ². Feature selection is done prior to evaluating EQ. (2) to ensure the matrix inverse is feasible. Cholesky factorization can be used to speed up calculation. Though the task here is classification, the classification labels are treated as regression labels and normalized before learning (i.e., subtract the mean such that Σᵢyᵢ=0). This model is sometimes referred to as the Bayesian ridge regression, since the log-likelihood, the logarithm of EQ. (1), is the negation of the ridge regression cost up to a constant factor,

l(y,w,X)=∥y−Xw∥²+λ∥w∥²

with λ=σ². One feature of Bayesian ridge regression is that there is a systematic way of optimizing λ from the data.

### Weighted Ridge Regression

Ridge regression is a known linear regression method and has been proven to be effective for classification tasks in the text mining domain. Suppose there is a sample set of pairs (xᵢ; yⁱ); i=1, . . . , N, where xᵢεR^{d} is the i^{-th} feature vector and y_{iε}{+1, −1} is the corresponding label. Denote XεR^{N×d} as the feature matrix whose i^{-th} row contains the features for the i^{-th} data point, and y the label vector of N labels. The conventional linear ridge regression constructs a hyperplane-based function w^{T}x to approximate the output y by minimizing the following loss function:

L_{RR}(w)=∥y−Xw∥²+λ∥w∥², (3)

where ∥ ∥ denotes the 2-norm of a vector and λ>0 is the regularization parameter. Here the first term is the least square loss of the output, and second term is the regularization term which penalizes a w with high norm. Here, λ balances off the two terms. Typically, λ=σ². By zeroing the derivative of L with respect to w, it can be seen that ridge regression has a closed-form solution

w=(X^{T}X+λI)⁻¹X^{T}y.

Traditional ridge regression sets equal weights to all the examples. When it is employed to solve classification tasks, such as text categorization, issues are encountered when the class distribution is highly unbalanced. For example, in the ICD-9 code database of 96,557 patient records, there are only have 774 records assigned to the code 410.41, which stands for “acute myocardial infarction of inferior wall”. Even if these patients are misclassified, there may be an acceptable cost value in the classic ridge regression setting. Moreover, some examples can be noisy due to contamination in the feature vectors or high uncertainty associated with the labels. It would be helpful to have different weights for different observations such that the costs of mislabeling are different.

This leads to the weighted ridge regression. Let αᵢ>0 be the weight for the i^{-th} observation. The optimal set of hyperplane parameters w can be found by minimizing the following loss function:

$$\begin{matrix}{L}_{WRR} ( w ) = {\sum }_{i} {{α}_{i} ( {y}_{i} - {w}^{T} {x}_{i} )}^{2} + λ {‖ w ‖}^{2} \\ = {( y - Xw )}^{T} A ( y - Xw ) + λ {‖ w ‖}^{2}\end{matrix} \qquad ( 4 )$$

where A is a N×N diagonal matrix with its (i; i)^{-th} entry being αᵢ. Correspondingly, the closed-form solution for the weighted ridge regression is:

w=(X^{T}AX+λI)⁻¹X^{T}Ay.

The regularization parameter λ and weight matrix A are useful for obtaining a good linear weight vector w. They can be tuned via a cross-validation procedure, though there are some other ways of estimating λ. According to an embodiment of the invention, there is a probabilistic interpretation for these methods and a principled way of adapting these parameters.

### Interpretation of Ridge Regression

Suppose the output yᵢ follows a Gaussian distribution with mean w^{T}xᵢ and variance σ², i.e., yᵢ˜N(w^{T}xᵢ, σ²), and the weight vector w follows a Gaussian prior distribution: w˜N(0, I). Then the negative log-posterior density of w is exactly the loss function defined in EQ. (3), with λ=σ². This interpretation is known in the art.

One feature of this interpretation is that one can optimize the regularization parameter λ=σ² by maximizing the marginal likelihood of the data, referred to as evidence maximization or the type-II likelihood:

$$log P ( y \vert {σ}^{2} ) = - \frac{N}{2} log 2 π - \frac{1}{2} log \vert {XX}^{T} + {σ}^{2} I \vert - \frac{1}{2} {{y}^{T} ( {XX}^{T} + {σ}^{2} I )}^{- 1} y .$$

Contrary to the conventional approach of selecting the regularization parameter by cross validation, one can also derive an expectation-maximization (EM) algorithm, taking was the missing data and σ² the model parameter. In this approach, one estimates the posterior distribution of w in the E-step, which is a Gaussian N(μ_{w}, C_{w}), with

μ_{w}=(X^{T}X+σ²I)⁻¹X^{T}y,

C_{w}=σ²(X^{T}X+σ²I)⁻¹.

Then in the M-step the “complete” log-likelihood is maximized with respect to a 2, assuming the posterior of w as given in the E-step. This leads to the following update for σ²:

$${σ}^{2} = \frac{1}{N} [ {‖ y - Xw ‖}^{2} + tr ( {XC}_{w} {X}^{T} ) ] .$$

An algorithm according to an embodiment of the invention iterates the E-step and M-step until convergence. The posterior mean of w can be used to make predictions for test observations, and one can also determine the variances of these predictions by considering the posterior covariance of w.

### Interpretation of Weighted Ridge Regression

When the weights of the observations are not fixed to be the same, there is also an interesting interpretation for weighted ridge regression. Instead of having a common variance term σ² for all the observations as in ridge regression, it is assumed in weighted ridge regression that

$${y}_{i} ∼ N ( {w}^{T} {x}_{i} , \frac{{σ}^{2}}{{α}_{i}} ) , \qquad ( 5 )$$

which means if the weight of the i^{-th} observation is high, the variance of the output is small. Here σ² is the common variance term shared by all the observations, and αᵢ is specific only to each observation i. With the same prior for w, i.e., w˜N(0, I), one can easily check that the negative log-posterior density of w is exactly the L_{WRR}(W) as defined in EQ, (4), with λ=σ².

A similar EM algorithm according to an embodiment of the invention can be derived to optimize σ² and αᵢ iteratively. In the E-step there is the estimated posterior of w as N(μ_{w}, C_{w}), with

μ_{w}=(X^{T}AX+σ²I)⁻¹X^{T}Ay, (6)

C_{w}=σ²(X^{T}AX+σ²I)⁻¹. (7)

Note how the weight matrix A influences the posterior mean and variance of w. In EQS. (6) and (7), the contribution of each observation i depends on the weight αᵢ: it contributes more if the weight is higher (i.e., this is a good and important observation) and contributes less if the weight is smaller (i.e., it is a noisy observation).

In the M-step, recalling that A(i, i)=αᵢ, there is

$${σ}^{2} = \frac{1}{N} [ {( y - Xw )}^{T} A ( y - Xw ) + tr ( {XC}_{w} {X}^{T} A ) ] , \\ {α}_{i} = \frac{{σ}^{2}}{{( {y}_{i} - {w}^{T} {x}_{i} )}^{2} + {x}_{i}^{T} {C}_{w} {x}_{i}} . \qquad ( 8 )$$

Since the scales of σ² and A are inter-dependent, since only the ratio σ²/αᵢ is of interest, one could normalize A such that tr(A)=1 after each update. Note that EQ. (8) provides one way to update the weights in a reweighted least square scheme, in which not only the residual but also a covariance term should be considered.

It can be seen from an EM algorithm according to an embodiment of the invention that the weight matrix A does not need to be a diagonal matrix in general. A non-diagonal A essentially assumes that the N outputs for these N observations are not independent and identically distributed sampled, i.e., y˜N(Xw, σ²A⁻¹). In the case of ICD-9 code classification, this is useful when one observation (i.e., one record) is only for one visit of a certain patient, and doctors need to consider the records from multiple visits (i.e., multiple observations) to make one decision (i.e., output). In practice, however, it is not always good to update the weight matrix A in this way, especially when there are a large number of observations. Overfitting is very likely to occur in this situation.

One can constrain the matrix A even further, to reduce the number of free parameters, by assuming some observations share a common weight. One exemplary, non-limiting choice is to assume all the positive observations share one weight α₊, and all the negative ones share α₋. The updates in this case will be

$${α}_{+} = \frac{1}{{N}_{+}} {\sum }_{\{ i \vert {y}_{i} = + 1 \}} \frac{{σ}^{2}}{{( {y}_{i} - {w}^{T} {x}_{i} )}^{2} + {x}_{i}^{T} {C}_{w} {x}_{i}} , \\ {α}_{-} = \frac{1}{{N}_{-}} {\sum }_{\{ i \vert {y}_{i} = - 1 \}} \frac{{σ}^{2}}{{( {y}_{i} - {w}^{T} {x}_{i} )}^{2} + {x}_{i}^{T} {C}_{w} {x}_{i}} ,$$

where N₊ and N₋ are the numbers of positive and negative examples, respectively. One might also normalize such that α₊+α₋=1.

The EM update for the α₊, and α₋ might not necessarily optimize the F1 or AUC (Area Under ROC Curve) measures because it only minimizes the regularized least square of classification errors. Therefore, according to an embodiment of the invention, the validation set is used to select optimal α₊, and α₋ that maximize the F1 in the experiments. Finally the E-step and M-step are iterated until convergence. As before one can use μ_{w} to make predictions for new observations.

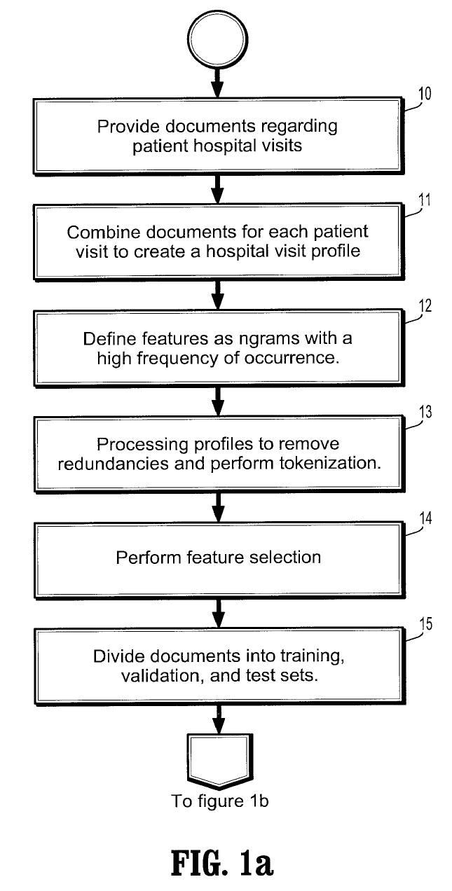

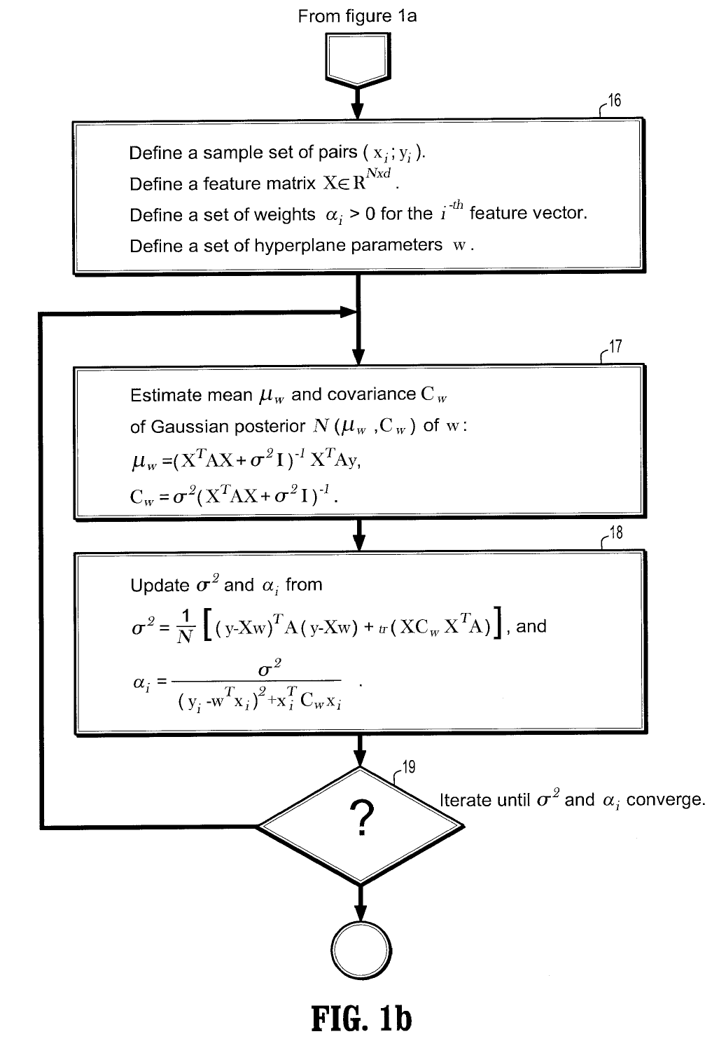

A flowchart of a method according to an embodiment of the invention for training classifiers for ICD-9 patient codes is shown in FIGS. 1a-b. Referring now to FIG. 1a, an exemplary method starts at step 10 by providing a set of documents regarding patient hospital visits. These documents can very from specific procedure reports to full hospital visit records for a particular patient. At step 11, these documents are combined for each patient visit to create a hospital visit profile. At step 12, a feature is defined as an ngram with a frequency of occurrence greater or equal to a predetermined value that does not appear in a standard list of ngrams, such as function words. The profiles are processed at step 13 to remove redundancy at a paragraph level and to perform tokenization and sentence splitting. Feature selection is performed at step 14, by, e.g., normalizing χ² values or information gain. At step 15, the documents randomly divided into training, validation, and test sets.

Moving on to FIG. 1b, an exemplary method continues at step 16 with some preliminaries for training a set of binary classifiers using said training set, where each binary classifier targets a single ICD-9 code. These preliminaries include defining a sample set of pairs (xᵢ;yᵢ), i=1, . . . , N, wherein xᵢεR^{d} is an i^{-th} feature vector and y_{iε} {+1, −1} is a corresponding ICD-9 label and y a label vector of N labels, defining a feature matrix XεR^{N×d} whose i^{-th} row contains features for an i^{-th} feature vector xᵢ, defining a set of weights αᵢ>0 for the i^{-th} feature vector xᵢ wherein A is a N×N diagonal matrix with its (i, i)^{-th} entry being αᵢ, and defining a set of hyperplane parameters w=(X^{T}AX+σ²I)⁻¹X^{T}Ay. The labels yᵢ follow a Gaussian distribution

$${y}_{i} ∼ N ( {w}^{T} {x}_{i} , \frac{{σ}^{2}}{{α}_{i}} )$$

with mean w^{T}xᵢ and variance

$$\frac{{σ}^{2}}{{α}_{i}} .$$

At step 17, a Gaussian posterior N(μ_{w}, C_{w}) of w with mean μ_{w} and covariance C_{w} is estimated by calculating

μ_{w}=(X^{T}AX+σ²I)⁻¹X^{T}Ay,

C_{w}=σ²(X^{T}AX+σ²I)⁻¹;

and at step 18, σ² and αⁱ are updated from

$${σ}^{2} = \frac{1}{N} [ {( y - Xw )}^{T} A ( y - Xw ) + tr ( {XC}_{w} {X}^{T} A ) ] , \\ {α}_{i} = \frac{{σ}^{2}}{{( {y}_{i} - {w}^{T} {x}_{i} )}^{2} + {x}_{i}^{T} {C}_{w} {x}_{i}} .$$

Steps 17 and 18 are repeated from step 19 until values of σ² and αⁱ have converged. Classifier parameters can be adjusted using said validation set, and the classifiers are tested on the test set. Each resulting classifier is adapted to determining a specific ICD-9 code by analyzing a patient's hospital records.

### Experiments

In this section is described the experimental setups and results using the previously mentioned dataset and approaches and compare results using weighted ridge regression with the canonical ridge regression and linear SVM.

Each document in the patient database represents an event in the patient's hospital stay: e.g. radiology note, personal physician note, lab tests etc. These documents are combined to create a hospital visit profile and are subsequently preprocessed for the classification task. No stemming is performed for the experiments described herein.

Experiments were limited to hospital visits with less than 200 doctor's notes. Very often, a previous doctor's note is copied and parts of it are modified as the patient visit progresses. This means that a document may contain redundant data that was not intended to provide additional information. As a first pre-processing step, redundancy at a paragraph level was eliminated and tokenization and sentence splitting was performed. In addition, tokens go through a number and pronoun classing smoothing process, in which all numbers are replaced with the same token, and all person pronouns are replaced with a similar token. Further classing could be performed: e.g. dates, entity classing etc, but were not considered in these experiments. As a shared pre-processing for all classifiers, viable features are considered to be unigrams with a frequency of occurrence greater or equal to a predetermined value that do not appear in a standard list of function words. An exemplary, non-limiting value is for the dataset described herein is 10.

After removing and consolidating patient visits from multiple documents, the corpus included almost 100,000 data points. The visits were randomly split into training, validation, and test sets. In one exemplary, non-limiting embodiment of the invention, these sets contained 70%, 15%, and 15% of the corpus respectively. Binary classifiers were trained for each individual diagnostic code (label), the validation set was used to adjust the parameters, and the classifiers were tested on the test set. The training set included 67,745 patient visits, which is probably the largest training set so far in the ICD-9 coding literature. This corpus is real-world, a corpus built on an actual patient database, and ICD-9 codes assigned by professionals, making these experiments more realistic compared to previous work, such as the medical text dataset used in the very recent Computation Medicine Center competition which uses overall only 2,216 sub-paragraph level documents.

Prior to training the classifiers on the dataset, feature selection was performed using χ². The top 1,500 features with the highest χ² values were selected to make up the feature vector. The previous step which reduced the vocabulary was necessary, since the χ² measure is unstable when infrequent features are used. To generate the feature vectors, the χ² values were normalized into the φ coefficient and then each vector was normalized to a Euclidean norm of 1.

Data for experiments with the five most frequent ICD-9 codes is presented herein for the canonical ridge regression and linear SVM. This allows for more in-depth experiments with only a few labels and also ensures sufficient training and testing data for the experiments. From a machine learning perspective, most of the ICD-9 codes are unbalanced: much less than half of the documents in the corpus actually have a given label. From a text processing perspective, this is a normal multi-class classification setting.

In these experiments, two classification approaches were used: support vector machine (SVM) and Bayesian ridge regression (BRR), for each of the ICD-9 codes. The validation set was used to tune the specific parameters for these approaches, and all the final results are reported using the unseen test set. For the Bayesian ridge regression, the validation set is used to determine the λ parameter as well as the best cutting point for positive versus negative predictions in order to optimize the F1 measure. Training is very fast for both methods when 1,500 features are selected using χ².

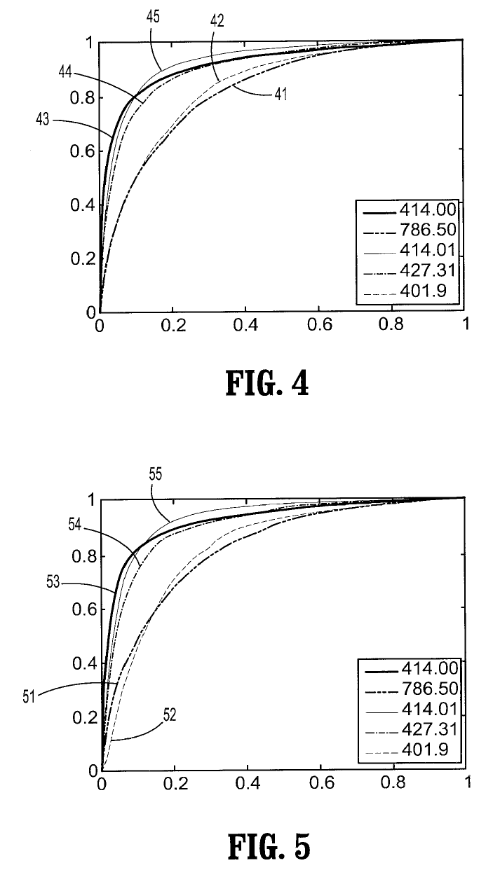

The models were evaluated using the Precision, Recall, AUC (Area under the Curve) and F1 measures. The results on the top five codes for both the support-vector machine and Bayesian ridge regression classification approaches are shown in the table of FIG. 3. For the same experiments, the receiver operating characteristic (ROC) curves of prediction are shown in FIGS. 4 and 5 the top five codes. Specifically, FIG. 4 curves 41, 42, 43, 44, and 45 are the ROC curves for the SVM experiments for ICD-9 codes 786.50, 401.9, 414.00, 427.31, and 414.01, respectively, and FIG. 5 curves 51, 52, 53, 54, and 55 are the ROC curves for the Bayesian ridge regression experiments for ICD-9 codes 786.50, 401.9, 414.00, 427.31, and 414.01, respectively. The support vector machine and Bayesian ridge regression methods obtain comparable results on these independent ICD-9 classification tasks. The Bayesian ridge regression method obtains a slightly better performance, but the difference is not statistically significant.

It should be noted that the results presented herein may underestimate the true performance of these classifiers. The classifiers are tested on ICD-9 codes labeled by medical abstractors, who, as stated in the background section, only have a 60%-80% accuracy. A better performance estimation might be obtained by adjudicating the differences using a medical expert.

Thus, both Support Vector Machines and Bayesian ridge regression methods are fast to train and achieve comparable results. The F1 measure performance on the unseen test data is between 0.6 to 0.75 for the tested ICD9 codes, and the AUC scores are between 0.8 to 0.95. These results support the conclusion that automatic code classification is a viable research direction and offers the potential to change clinical coding.

### Experiments Using Weighted Ridge Regression

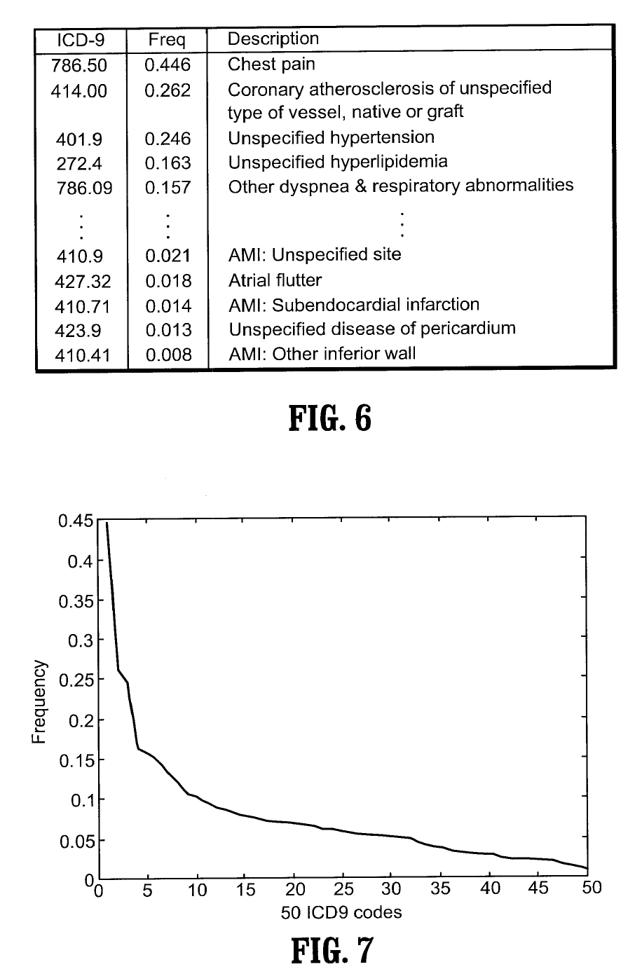

In these experiments the 50 most frequently appearing codes were used, some of which are listed in the table of FIG. 6 with frequencies (the percentage of positive examples over all documents) and descriptions, in the order of decreasing frequency. FIG. 7 plots the percentage for each of 50 codes. The figure clearly shows that around 80% of 50 codes have less than 10% of instances over the entire corpus, which attests the unbalance of ICD-9 codes.

Variation of Performance with Respect to α

First is described a simple test to validate a method according to an embodiment of the invention. A fixed α is assigned to the training examples with positive labels, and (1−α) to the examples with negative labels respectively. Hence there is a convex combination weighting on the training examples by varying a between 0 and 1. When α=0:5, the weighted ridge regression reduces to the conventional ridge regression. Therefore variations of different performance measures with respect to a indicate the performance of a weighted method according to an embodiment of the invention.

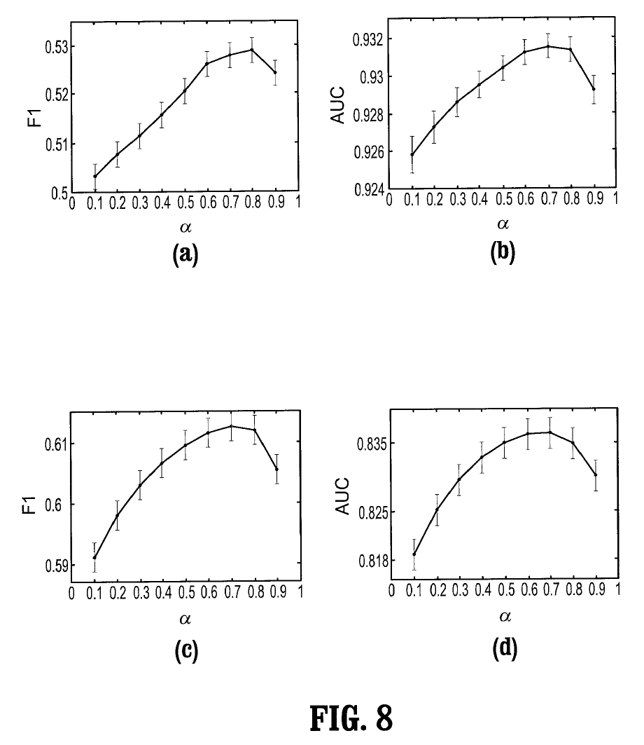

The training data was randomly split into 100 folds, each time 99 folds were use as training examples for a given a, and the performance of the trained model was evaluated on the remaining 1 fold original samples. Variations of the F1 and AUC with respect to a for two representative ICD-9 codes, 250.00 and 401.9, are shown in FIGS. 8(a)-(b) and FIGS. 8(c)-(d), respectively. Code 250.00 (diabetes mellitus) only appears 4,811 times out of overall 96,557 data samples in the whole corpus, while code 401.9 (unspecified hypertension) has 23,720 instances. The mean values of F1 and AUC measured out of 100 Monte Carlo simulations are plotted as functions of weight α with error bars for the standard deviations. These figures clearly show the effects of different weighting on the performance of a weighted ridge regression in terms of F1 and AUC. As a weighted ridge regression assigns more weight on the training examples with positive labels, the performance improves. However, over-weighting might deteriorate the results. An optimal a can be selected depending on the performance measure choosen. By selecting an optimal a, the weighted ridge regression outperforms the conventional un-weighted ridge regression (α=0:5 in the figures).

### Results

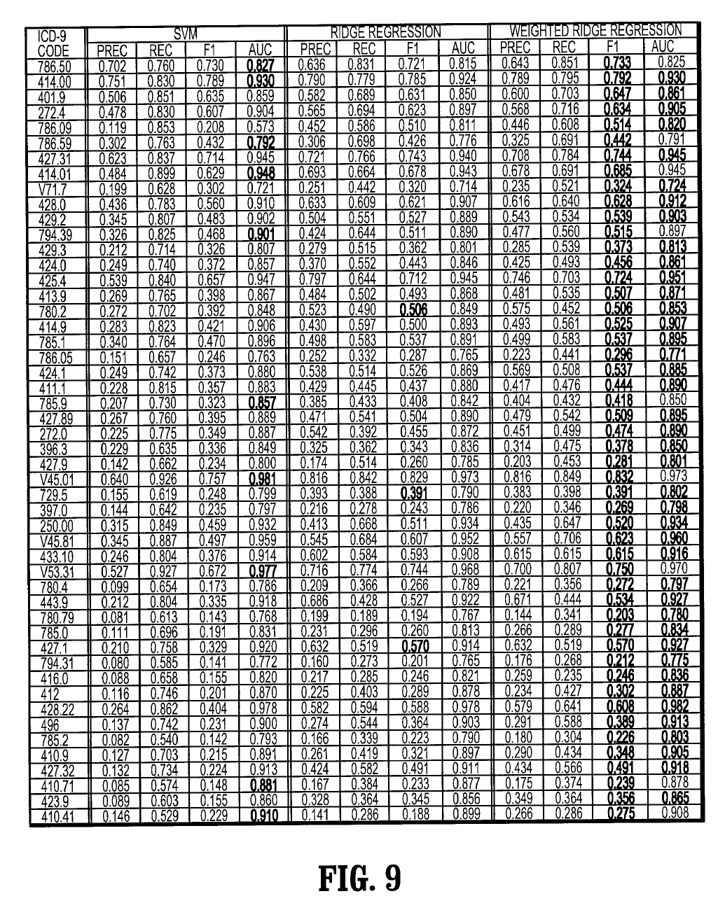

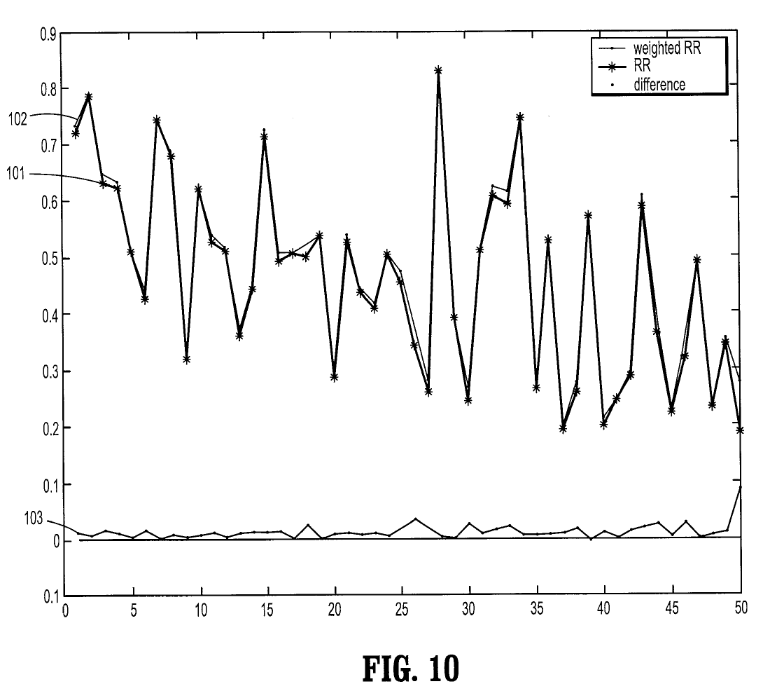

Classification results on 50 ICD-9 codes with a weighted ridge regression method according to an embodiment of the invention, the canonical ridge regression and linear SVM, are presented herein. The comparison measures are given by the precision, recall, F1 and AUC. The precision, recall and F1 measures are standard criteria in text classification. The AUC criterion offers an overall performance for a classifier. The SVM light toolkit with a linear kernel and default regularization parameter was used. In the experiment, the cost factor was set as the number of negative training examples over the positive one. FIG. 9 is a table that shows the experiment results for the precision, recall, F1, and AUC over all 50 ICD-9 codes for SVM, the canonical ridge regression and the weighted ridge regression. FIG. 10 is a graph of the F1 curves for the canonical ridge regression 101, the weighted ridge regression 102, and the difference curve 103, for the top 50 ICD-9 codes. The order of the codes is sorted by the frequency of codes with the most frequent ones on the top. The maximum values are highlighted over 3 methods for the F1 and AUC measures. As the data becomes more and more unbalanced, the performance of SVM deteriorates even though the cost factor was set accordingly. The weighted ridge regression achieves better results over the canonical ridge regression. For some codes with extreme unbalance, significant improvements can be seen in the table. For example, a weighted ridge regression according to an embodiment of the invention has a 9% improvement in F1 over a canonical ridge regression for the code 410.41, the most infrequent code in the corpus. These results suggest that a weighted ridge method according to an embodiment of the invention outperforms canonical ridge regression and SVM for unbalanced ICD-9 code classification.

### System Implementations

It is to be understood that embodiments of the present invention can be implemented in various forms of hardware, software, firmware, special purpose processes, or a combination thereof. In one embodiment, the present invention can be implemented in software as an application program tangible embodied on a computer readable program storage device. The application program can be uploaded to, and executed by, a machine comprising any suitable architecture.

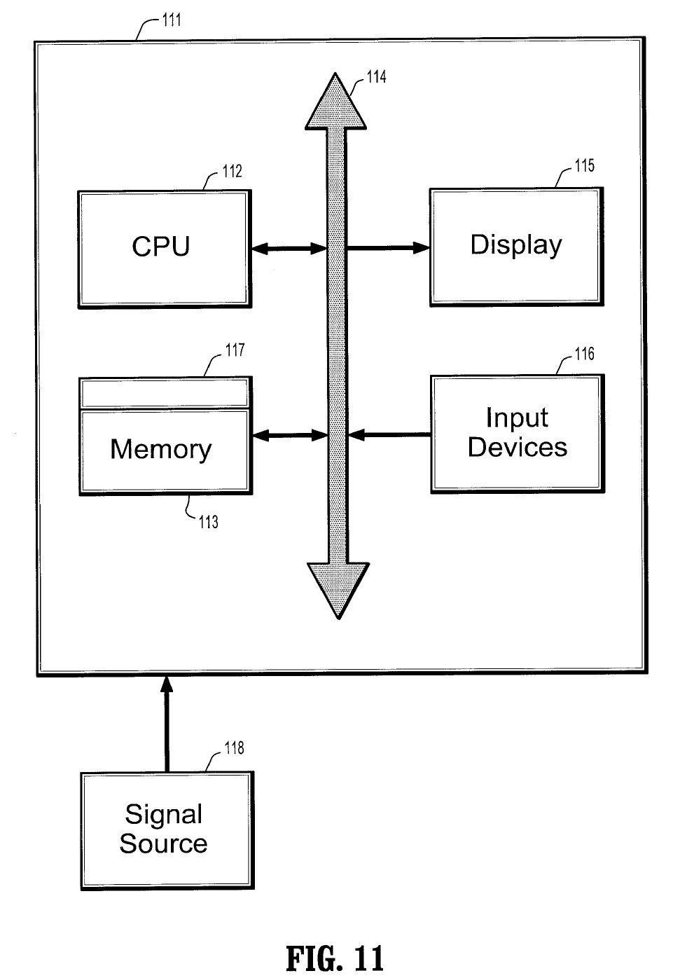

FIG. 11 is a block diagram of an exemplary computer system for implementing a method for accurate labeling of patient records according to diagnoses and procedures that patients have undergone according to an embodiment of the invention. Referring now to FIG. 11, a computer system 111 for implementing the present invention can comprise, inter alia, a central processing unit (CPU) 112, a memory 113 and an input/output (I/O) interface 114. The computer system 111 is generally coupled through the I/O interface 114 to a display 115 and various input devices 116 such as a mouse and a keyboard. The support circuits can include circuits such as cache, power supplies, clock circuits, and a communication bus. The memory 113 can include random access memory (RAM), read only memory (ROM), disk drive, tape drive, etc., or a combinations thereof. The present invention can be implemented as a routine 117 that is stored in memory 113 and executed by the CPU 112 to process the signal from the signal source 118. As such, the computer system 111 is a general purpose computer system that becomes a specific purpose computer system when executing the routine 117 of the present invention.

The computer system 111 also includes an operating system and micro instruction code. The various processes and functions described herein can either be part of the micro instruction code or part of the application program (or combination thereof) which is executed via the operating system. In addition, various other peripheral devices can be connected to the computer platform such as an additional data storage device and a printing device.

It is to be further understood that, because some of the constituent system components and method steps depicted in the accompanying figures can be implemented in software, the actual connections between the systems components (or the process steps) may differ depending upon the manner in which the present invention is programmed. Given the teachings of the present invention provided herein, one of ordinary skill in the related art will be able to contemplate these and similar implementations or configurations of the present invention.

While the present invention has been described in detail with reference to a preferred embodiment, those skilled in the art will appreciate that various modifications and substitutions can be made thereto without departing from the spirit and scope of the invention as set forth in the appended claims.

What is claimed is:

1. A method for training classifiers for ICD-9 patient codes, said method comprising the steps of:
providing a set of documents regarding patient hospital visits;
combining said documents for each patient visit to create a hospital visit profile;
defining a feature as an ngram with a frequency of occurrence greater or equal to a predetermined value that does not appear in a standard list of ngrams;
processing said profiles to remove redundancy at a paragraph level and perform tokenization and sentence splitting;
performing feature selection;
randomly dividing said documents into training, validation, and test sets; and
training a set of binary classifiers, each binary classifier targeting a single ICD-9 code using said training set, wherein each said classifier is adapted to determining a specific ICD-9 code by analyzing a patient's hospital records.

2. The method of claim 1, wherein documents include specific procedure reports and full hospital visit records for a particular patient.

3. The method of claim 1, further comprising processing said tokens including replacing all numbers with a same token, replacing all personal pronouns with a similar token, and replacing other classes of words/ngrams with special tokens.

4. The method of claim 1, further comprising adjusting classifier parameters using said validation set, and testing said classifiers on the test set.

5. The method of claim 1, wherein said binary classifier is trained using a support vector machine with a linear kernel.

6. The method of claim 5, wherein a cost function of said support vector machine assigns equal value to all ICD-9 classes.

7. The method of claim 5, wherein a cost function of said support vector machine assigns a class cost equal to a ratio of negative to positive examples.

8. The method of claim 1, wherein said binary classifier is trained using a Bayesian ridge regression using a Gaussian prior of form w˜N(μ_{w},Σ_{w}), with mean μ_{w} and covariance Σ_{w} for parameter vector w, wherein w^{T}x approximates an ICD-9 code label y for a feature vector x, with y_{iε}{+1, −1} indicating whether said feature vector x is associated with said ICD-9 code, and a likelihood of labels y=[y₁, . . . , yₙ]^{T}
$$P ( y ) = \int {\prod }_{i = 1}^{n} P ( {y}_{i} \vert {w}^{T} {x}_{i} ) P ( w \vert {μ}_{w} , {Σ}_{w} ) d w ,$$
with P(yᵢ|w^{T}xᵢ) being a probability that features xᵢ take the label yᵢ., wherein P(yᵢ|w^{T}xᵢ) is a Gaussian, with yᵢ˜N(w^{T}xᵢ, σ²), and σ² is a model parameter.

9. The method of claim 8, wherein the model parameter σ² is determined by maximizing the likelihood of labels with respect to or σ².

10. The method of claim 1, wherein training a binary classifier comprises:
defining a sample set of pairs (xᵢ; yᵢ), i=1, . . . , N, wherein xᵢεR^{d} is an i^{-th} feature vector and γ_{iε}{+1, −1} is a corresponding ICD-9 label and y a label vector of N labels;
defining a feature matrix XεR^{N×d} whose i^{-th} row contains features for an i^{-th} feature vector xᵢ;
defining a set of weights αᵢ>0 for the i^{-th} feature vector xᵢ wherein A is a N×N diagonal matrix with its (i, i)^{-th} entry being αᵢ;
defining a set of hyperplane parameters w=(X^{T}AX+σ²I)⁻¹X^{T}Ay;
estimating a Gaussian posterior N(μ_{w}, C_{w}) of w with mean μ_{w} and covariance C_{w} by calculating
μ_{w}=(X^{T}AX+σ²I)⁻¹X^{T}Ay,
C_{w}=σ²(X^{T}AX+σ²I)⁻¹;
and updating σ² and αᵢ from
$${σ}^{2} = \frac{1}{N} [ {( y - Xw )}^{T} A ( y - Xw ) + tr ( {XC}_{w} {X}^{T} A ) ] , \\ {α}_{i} = \frac{{σ}^{2}}{{( {y}_{i} - {w}^{T} {x}_{i} )}^{2} + {x}_{i}^{T} {C}_{w} {x}_{i}} ;$$
and repeating said steps of estimating said Gaussian posterior N(μ_{w}, C_{w}) and updating σ² and αᵢ until values of σ² and αᵢ have converged.

11. The method of claim 10, wherein the labels yᵢ follow a Gaussian distribution
$${y}_{i} ∼ N ( {w}^{T} {x}_{i} , \frac{{σ}^{2}}{{α}_{i}} )$$
with mean w^{T}xᵢ and variance
$$\frac{{σ}^{2}}{{α}_{i}} .$$

12. The method of claim 10, further comprising normalizing A such that tr(A)=1 after each update.

13. The method of claim 10, further comprising constraining all positive-labeled feature vectors to share one weight α₊, and all the negative labeled feature vectors to share one weight α₋, wherein said updates are
$${α}_{+} = \frac{1}{{N}_{+}} {\sum }_{\{ i \vert {y}_{i} = + 1 \}} \frac{{σ}^{2}}{{( {y}_{i} - {w}^{T} {x}_{i} )}^{2} + {x}_{i}^{T} {C}_{w} {x}_{i}} , \\ {α}_{-} = \frac{1}{{N}_{-}} {\sum }_{\{ i \vert {y}_{i} = - 1 \}} \frac{{σ}^{2}}{{( {y}_{i} - {w}^{T} {x}_{i} )}^{2} + {x}_{i}^{T} {C}_{w} {x}_{i}} ,$$
where N₊ and N₋ are the numbers of positive and negative feature vectors, respectively.

14. The method of claim 13, further comprising normalizing α₊+α₋=1.

15. A method for training classifiers for ICD-9 patient codes, said method comprising the steps of:
extracting a set of feature vectors from a set of documents regarding patient hospital visits wherein each document is a full hospital visit record for a particular patient, wherein each said feature vector is associated with an ICD-9 code;
training a set of binary classifiers, each targeting a specific ICD-9 code, by defining a sample set of pairs as (xᵢ; yᵢ); i=1, . . . , N, wherein xᵢεR^{d} is an i^{-th} feature vector and y_{iε}{+1, −1} is a corresponding ICD-9 label and y a label vector of N labels, a feature matrix XεR^{N×d} whose i^{-th} row contains features for an i^{-th} feature vector, weights αᵢ>0 for the i^{-th} feature vector wherein A is a N×N diagonal matrix with its (i, i)^{-th} entry being αᵢ, and a set of hyperplane parameters w=(X^{T}AX+σ²I)⁻¹X^{T}Ay;
estimating a Gaussian posterior N(μ_{w}, C_{w}) of w with mean μ_{w} and covariance C_{w} estimated as
μ_{w}=(X^{T}AX+σ²I)⁻¹X^{T}Ay,
C_{w}=σ²(X^{T}AX+σ²I)⁻¹;
updating σ² and αᵢ from
$${σ}^{2} = \frac{1}{N} [ {( y - Xw )}^{T} A ( y - Xw ) + tr ( {XC}_{w} {X}^{T} A ) ] , \\ {α}_{i} = \frac{{σ}^{2}}{{( {y}_{i} - {w}^{T} {x}_{i} )}^{2} + {x}_{i}^{T} {C}_{w} {x}_{i}} ,$$
and repeating said steps of estimating said Gaussian posterior N(μ_{w}, C_{w}) and updating σ² and αᵢ until values of σ² and αᵢ have converged, wherein each said classifier is adapted to determining a specific ICD-9 code by analyzing a patient's hospital records.

16. The method of claim 15, wherein extracting a set of feature vectors comprises:
providing a set of documents regarding patient hospital visits;
combining said documents for each patient visit to create a hospital visit profile;
defining a feature as a ngram with a frequency of occurrence greater or equal to a predetermined value that does not appear in a standard list of ngrams;
processing said profiles to remove redundancy at a paragraph level and perform tokenization and sentence splitting;
performing feature selection;
randomly dividing said documents into training, validation, and test sets, wherein said training set is used to train said binary classifiers; and further comprising
adjusting classifier parameters using said validation set, and testing said classifiers on the test set.

17. A program storage device readable by a computer, tangibly embodying a program of instructions executable by the computer to perform the method steps for training classifiers for ICD-9 patient codes, said method comprising the steps of:
providing a set of documents regarding patient hospital visits;
combining said documents for each patient visit to create a hospital visit profile;
defining a feature as an ngram with a frequency of occurrence greater or equal to a predetermined value that does not appear in a standard list of ngrams;
processing said profiles to remove redundancy at a paragraph level and perform tokenization and sentence splitting;
performing feature selection;
randomly dividing said documents into training, validation, and test sets; and
training a set of binary classifiers, each binary classifier targeting a single ICD-9 code using said training set, wherein each said classifier is adapted to determining a specific ICD-9 code by analyzing a patient's hospital records.

18. The computer readable program storage device of claim 17, wherein documents include specific procedure reports and full hospital visit records for a particular patient.

19. The computer readable program storage device of claim 17, the method further comprising processing said tokens including replacing all numbers with a same token, replacing all personal pronouns with a similar token, and replacing other classes of words/ngrams with special tokens.

20. The computer readable program storage device of claim 17, the method further comprising adjusting classifier parameters using said validation set, and testing said classifiers on the test set.

21. The computer readable program storage device of claim 17, wherein said binary classifier is trained using a support vector machine with a linear kernel.

22. The computer readable program storage device of claim 21, wherein a cost function of said support vector machine assigns equal value to all ICD-9 classes.

23. The computer readable program storage device of claim 21, wherein a cost function of said support vector machine assigns a class cost equal to a ratio of negative to positive examples.

24. The computer readable program storage device of claim 17, wherein said binary classifier is trained using a Bayesian ridge regression using a Gaussian prior of form w˜N(μ_{w},Σ_{w}), with mean μ_{w} and covariance Σ_{w} for parameter vector w^{T}x wherein w^{T}x approximates an ICD-9 code label y for a feature vector x, with y_{iε}{+1, 1} indicating whether said feature vector x is associated with said ICD-9 code, and a likelihood of labels y=[y₁, . . . , yₙ]^{T}
$$P ( y ) = \int {\prod }_{i = 1}^{n} P ( {y}_{i} \vert {w}^{T} {x}_{i} ) P ( w \vert {μ}_{w} , {Σ}_{w} ) d w ,$$
with P(yᵢ|w^{T}xᵢ) being a probability that features xᵢ take the label yᵢ, wherein p(yᵢ|w^{T}xᵢ) is a Gaussian, with yᵢ˜N(w^{T}xᵢ, σ²), and σ² is a model parameter.

25. The computer readable program storage device of claim 24, wherein the model parameter σ² is determined by maximizing the likelihood of labels with respect to σ².

26. The computer readable program storage device of claim 17, wherein training a binary classifier comprises:
defining a sample set of pairs (xᵢ; yᵢ), i=1, . . . , N, wherein xᵢεR^{d} is an i^{-th} feature vector and y_{iε}{+1, −1} is a corresponding ICD-9 label and y a label vector of N labels;
defining a feature matrix XεR^{N×d} whose i^{-th} row contains features for an i^{-th} feature vector xᵢ;
defining a set of weights αᵢ>0 for the i^{-th} feature vector xᵢ wherein A is a N×N diagonal matrix with its (i, i)^{-th} entry being αᵢ;
defining a set of hyperplane parameters w=(X^{T}AX+σ²I)⁻¹X^{T}Ay;
estimating a Gaussian posterior N(μ_{w}, C_{w}) of w with mean μ_{w} and covariance C_{w} by calculating
μ_{w}=(X^{T}AX+σ²I)⁻¹X^{T}Ay,
C_{w}=σ²(X^{T}AX+σ²I)⁻¹;
and updating σ² and αᵢ from
$${σ}^{2} = \frac{1}{N} [ {( y - Xw )}^{T} A ( y - Xw ) + tr ( {XC}_{w} {X}^{T} A ) ] , \\ {α}_{i} = \frac{{σ}^{2}}{{( {y}_{i} - {w}^{T} {x}_{i} )}^{2} + {x}_{i}^{T} {C}_{w} {x}_{i}} ;$$
and repeating said steps of estimating said Gaussian posterior N(μ_{w}, C_{w}) and updating σ² and αᵢ until values of σ² and αⁱ have converged.

27. The computer readable program storage device of claim 26, wherein the labels yᵢ follow a Gaussian distribution
$${y}_{i} ∼ N ( {w}^{T} {x}_{i} , \frac{{σ}^{2}}{{α}_{i}} )$$
with mean w^{T}xᵢ and variance
$$\frac{{σ}^{2}}{{α}_{i}} .$$

28. The computer readable program storage device of claim 26, the method further comprising normalizing A such that tr(A)=1 after each update.

29. The computer readable program storage device of claim 26, the method further comprising constraining all positive-labeled feature vectors to share one weight α₊, and all the negative labeled feature vectors to share one weight α₋, wherein said updates are
$${α}_{+} = \frac{1}{{N}_{+}} {\sum }_{\{ i \vert {y}_{i} = + 1 \}} \frac{{σ}^{2}}{{( {y}_{i} - {w}^{T} {x}_{i} )}^{2} + {x}_{i}^{T} {C}_{w} {x}_{i}} , \\ {α}_{-} = \frac{1}{{N}_{-}} {\sum }_{\{ i \vert {y}_{i} = - 1 \}} \frac{{σ}^{2}}{{( {y}_{i} - {w}^{T} {x}_{i} )}^{2} + {x}_{i}^{T} {C}_{w} {x}_{i}} ,$$
where N₊ and N₋ are the numbers of positive and negative feature vectors, respectively.

30. The computer readable program storage device of claim 29, the method further comprising normalizing α₊+α₋=1.
